(19) United States
(12) Patent Application Publication
(10) Pub. No.: US 2003/0086449 A1
(43) Pub. Date: May 8, 2003

(54) Generator of short light pulses

(75) Inventors: Joel Jacquet, Limours (FR); Guang-Hua Duan, Chatenay Malabry (FR)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/270,067

(22) Filed: Oct. 15, 2002

(30) Foreign Application Priority Data
Oct. 15, 2001 (FR) 01 13 260

(51) Int. Cl. H01S 3/098; H01S 3/10; H01S 3/08

(52) U.S. Cl. 372/25; 372/96; 372/18

(57) ABSTRACT

A light pulse generator (1) having a distributed Bragg reflector is characterized in that the reflector is a sampled Bragg reflector grating (40) a plurality of reflection peaks, each peak corresponding to a reflection frequency value, the difference between consecutive reflection frequency values being equal to an integer multiple P of the difference between consecutive values of mode frequency at which an optical cavity formed between a rear face (13′) of an active layer and a reflection point of the reflector (40) is resonant. Very short pulses are thus obtained with low time jitter.

### DESCRIPTION

1. Technical Field

The invention lies in the field of light pulse generators comprising an active laser portion inside a resonant cavity defined by a first reflector and a second reflector which is a Bragg reflector, the cavity having a plurality of resonant modes, each resonant mode corresponding to a mode frequency.

2. Prior Art

There exist several techniques for creating short light pulses by means of a semiconductor laser. These techniques can be classified into three categories.

A first category of techniques uses semiconductor lasers with gain switching.

That technique is in widespread use because of its simplicity. The widths of the pulses produced are of the order of 15 picoseconds (ps). The pulses are heavily wavelength-modulated (“chirped”).

A second category of techniques uses absorption or Q-switched lasers.

A saturable absorbent is included in the structure of the laser. External modulation or passive switching of absorption serves to obtain pulses that are short.

A third category of techniques uses mode-locked lasers.

That technique is very widespread. At present it gives the best results in terms of pulse width and in terms of repetition frequency. Thus, mode-locked lasers have made it possible to obtain repetition frequencies of 40 gigahertz (GHz), see article [1] referenced in an appendix to the present description. It has also enabled pulse widths to be obtained that as short as 180 femtoseconds (fs), see article [2] whose reference appears in the appendix to the present description.

Although the above-mentioned results have been achieved under special conditions, mode-locked lasers are normally used under conditions such that only a fraction of the gain bandwidth of the semiconductor medium is used, typically less than 5 nanometers (nm) whereas the usable bandwidth is about 40 nm to 100 m. As a result, the pulses obtained are relatively broad, generally greater than 0.5 ps. In addition, jitter, i.e. time drift from one pulse to another, is large, particularly for the narrowest pulses.

### BRIEF DESCRIPTIONS OF THE INVENTION

Compared with the prior art described above, the invention seeks to provide a mode-locked semiconductor laser light pulse generator capable of generating very short duration pulses at a stable repetition frequency. The invention seeks to obtain this result in a manner that is simple and reproducible so as to limit manufacturing costs.

According to the invention, provision is made to use a mode-locked semiconductor laser coupled with a reflecting waveguide having a sampled Bragg grating. Mode-locked semiconductor lasers are known that have been coupled to a reflecting waveguide having a Bragg reflector. In such a laser, a Fabry-Perot resonant cavity is formed between a rear reflecting face of the cavity and the distributed Bragg reflector. In the invention, instead of using a simple Bragg reflector grating, a sampled Bragg reflector grating is used. In a manner that is in itself known, such a grating is constituted is by a plurality of identical sections, each constituted by a uniform portion of waveguide without a Bragg grating and by a uniform portion of waveguide with a Bragg grating (referred to as a “sample”). It has been shown that such a grating generates multiple reflection peaks, with each reflection peak corresponding to reflection of light at a particular frequency value (see article [3] whose reference appears in the appendix to the present description). Furthermore, if the reflection point of the sampled grating waveguide is positioned to co-operate with the rear face of the laser in such a manner as to constitute a cavity of longitudinal dimensions that induce resonant modes of said cavity for said reflection frequencies, then emission takes place simultaneously over a broad spectrum of frequencies, and consequently it is possible to generate light pulses of very narrow width. The sampling period of the sampled waveguide, i.e. the distance between two consecutive samples, makes it possible to adjust the value of the repetition frequency of the laser pulses emitted by the laser as constituted in this manner.

To sum up, the invention provides a light pulse generator including an active laser medium within a resonant cavity defined between two reflectors, constituting a first reflector and a second reflector, the cavity presenting mode frequency values at which the cavity is resonant, the second reflector being constituted by a Bragg reflector, the generator being characterized in that said Bragg reflector is constituted by a sampled Bragg grating presenting a plurality of reflection peaks, each peak corresponding to a reflection frequency value, and in that the difference between consecutive reflection frequency values is equal to an integer multiple P of the difference between consecutive values of the mode frequencies.

The integer multiple P may take in particular the value 1, such that the difference between consecutive reflection frequency values can also be equal to the difference between consecutive mode frequency values.

The integer multiple P may naturally take any value that is greater than or equal to 1, such as 1, 2, 3, or more. Selecting values greater than 1, such as 2 or 3, for example, makes it possible to use smaller spacings for resonant modes of the Fabry-Perot cavity, and thus to use longer lengths of the active medium. This can be used to obtain higher output powers.

In an embodiment, the Bragg reflector grating presents varying pitch which decreases on going away from said first reflector.

The Bragg reflector grating may also be modulated in depth of etching in a longitudinal direction of the grating.

The waveguide may be an optical fiber coupled to the active medium. It may also be integrated on the same chip as an active portion of the chip including the active medium, a propagation medium of the waveguide being situated in line with the active medium forming the active layer of said active portion.

In an embodiment, a waveguide layer including the laser active medium is made up of two portions, namely a first portion and a second portion situated in line with each other, said two portions belonging respectively to first and second sections, each of these sections having its own control input.

In this embodiment, the first section may, for example, be a gain section. The second section may be a phase matching section, for example. The effective group index of the semiconductor medium of said phase-matching second section is adjustable by the electro-optical effect, i.e. by changing the value of an electrical magnitude applied to said second section. By way of example, the second section may also be a section in which the semiconductor medium is constituted by a saturable absorption layer.

### BRIEF DESCRIPTION OF THE DRAWINGS

Embodiments of the invention are described below with reference to the accompanying drawings, in which:

FIG. 1 is a diagram showing a general embodiment of the invention.

FIG. 2 shows a sampled grating induced in a waveguide or a fiber.

FIG. 3 comprises three portions A, B, and C having a common frequency scale in which portion A shows the spacing between the reflection peaks of the sampled Bragg reflector, portion B shows the frequency values corresponding to resonant modes of the cavity formed between the rear face and the Bragg reflector, and portion C shows the emission spectrum of laser pulses emitted by the laser of the invention for P=1.

FIG. 4 is a diagram of an embodiment of a portion of a laser in accordance with the invention in which the waveguide layer is included in a first portion which is a gain section and in a second portion which is a phase-matching section, the two waveguide portions being placed in line with each other.

FIG. 5 is a diagram of an embodiment of a portion of the laser in accordance with the invention in which a waveguide layer is included in a first portion which is a gain section and in a second portion which is a saturable absorption section, the two waveguide portions being placed in line with each other.

FIG. 6 is a diagram of an embodiment of the invention in which the sampled waveguide is made in a waveguide integrated on the same chip as the active portion.

FIG. 7 is a diagram of a portion of a wavelength division multiplexed (WDM) network of conventional type using an integer number P of laser generators of the invention.

FIG. 8 plots the frequency combs of a portion of an integer number P of lasers of the invention along a frequency axis, said lasers being used in a WDM telecommunications network.

### DESCRIPTION OF EMBODIMENTS

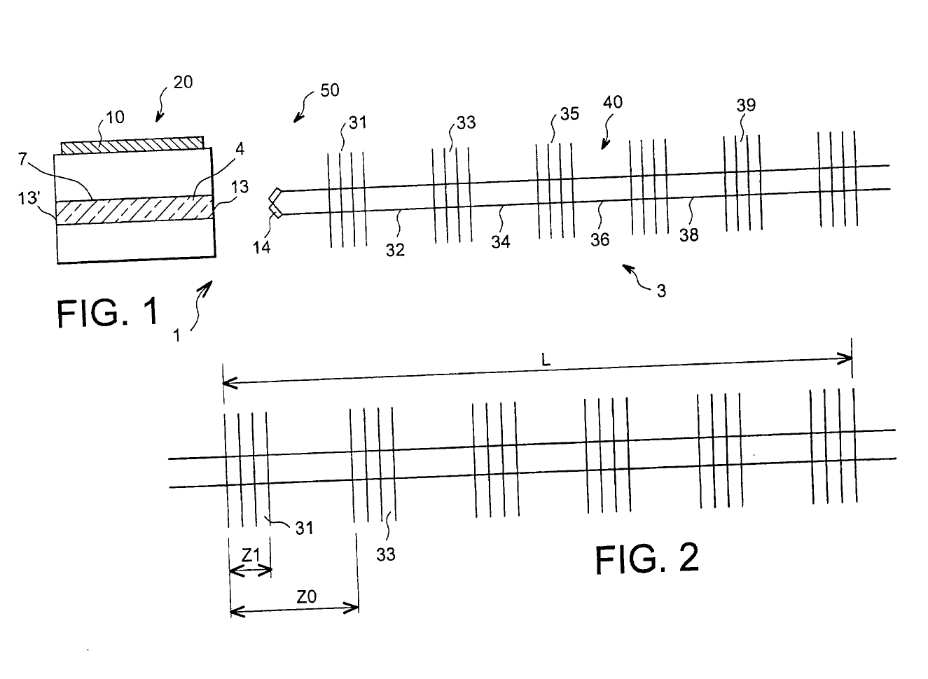

FIG. 1 is a diagram of a general embodiment of a laser 1 in accordance with the invention.

It shows an active portion 20 having a semiconductor laser structure, e.g. a surface strip. In conventional manner, the active portion 20 has an active layer 4. The active layer 4 is placed in conventional manner between electrical and optical confinement layers that are not referenced in the figures. A metal contact layer 10, e.g. of AuPt, is situated above the confinement layers to co-operate with a bottom electrode (not shown). A Fabry-Perot cavity 50 is made up of two portions that are coupled together. A first portion 7 of the Fabry-Perot cavity 50 is constituted by said active layer 4. A rear face 13′ of said layer is cleaved or treated to present a high coefficient of reflection, and thus constitutes a first reflector of the cavity. A front face 13 of said active layer is processed to present a coefficient of reflection that is as low as possible, and if possible zero.

The material of the active layer 4 is selected to present amplification gain over a broad bandwidth and to be capable of receiving direct modulation at high frequency, e.g. at 10 GHz to 20 GHz or more. A waveguide 3, e.g. an optical fiber as shown in FIG. 1, is placed longitudinally in line with the active cavity 4. The waveguide 3 is optically coupled with the laser layer 4, and preferably in this embodiment it is coupled by means of a coupling lens 14.

To constitute a second reflector of the cavity, a sampled-grating distributed-Bragg reflector (SGDBR) 40 is etched in the waveguide 3. The sampled-grating 40 (SG) is constituted by alternating samples of the distributed Bragg-reflector (DBR) type 31, 33, . . . , 39 and by sections 32, 34, . . . , 38 each constituted by a portion of waveguide having no Bragg grating sample. The rear reflecting face 13′ and the Bragg reflector 40 together form the Fabry-Perot cavity 50.

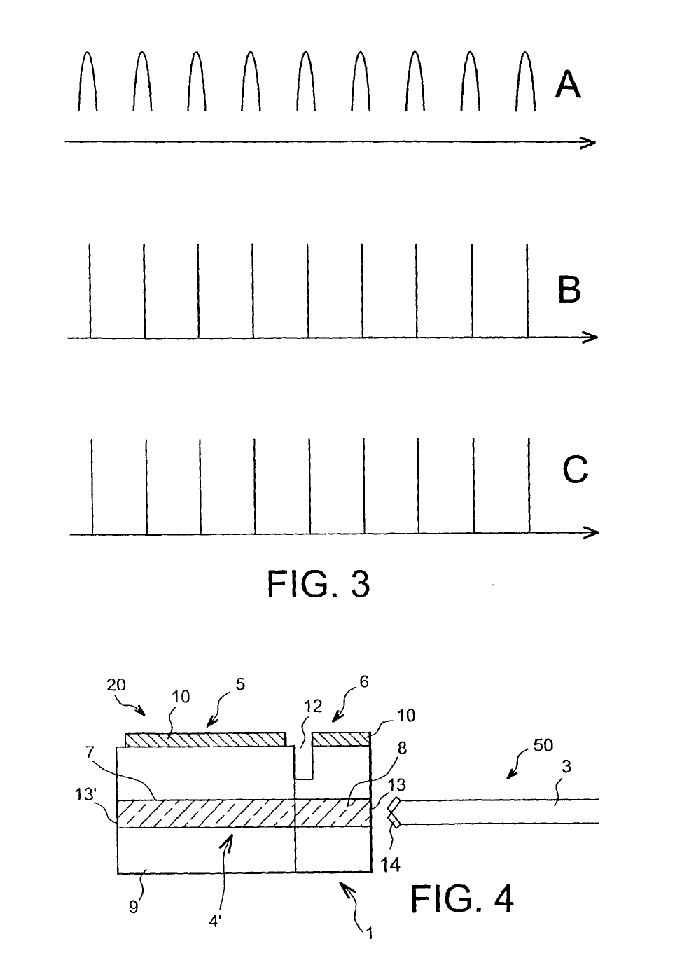

The mode of operation of the laser generator 1 in accordance with the invention as shown in FIG. 1, and further details concerning the Bragg reflector 40 are explained and commented on below with reference to FIGS. 2 and 3.

The sampling period Z0 shown in FIG. 2 is defined as being the distance between the beginnings of two consecutive etched zones 31 and 33. Each etched zone is of length Z1 and it is etched with a grating pitch A. In conventional manner, such a grating presents multiple reflection peaks. The frequency spacing ΔvSG between two consecutive reflection peaks is given by the formula:

ΔvSG=c/2n_{gf}Z0 (1)

In which formula:

c is the speed of light in a vacuum; and

n_{gf} is the group index of the fiber or the waveguide.

The sampling period Z0 of the waveguide is selected so as to obtain a frequency spacing ΔvSG between two consecutive reflection peaks that correspond to the pulse repetition frequency that the laser generator of the invention is to generate. For example, for a repetition frequency of 40 GHz, it is necessary to have a period of about 2.5 millimeters (mm) in a silica fiber that has group index of 1.5.

The center wavelength λ_{B} of the periodic Bragg grating etched in each zone 31, 33, 35, . . . of length Z2 is a function of the grating period Λ and of the index n of the waveguide or fiber in application of the following formula:

λ_{B}=2nΛ (2)

This Bragg wavelength corresponds to the mean frequency of the reflection peaks of the sampled grating.

The spectrum width of the envelope of the reflection comb formed by the set of reflection peaks is determined by the length Z1 of each etched zone. The Bragg wavelength λ_{B}, the frequency spacing ΔvSG between two consecutive reflection peaks, and the number of reflection peaks can thus be controlled accurately when making the grating by suitably selecting values for parameters such as the length Z0 of the grating periods, the length Z1 of each etched portion, the pitch Λ of each etched portion, and the length L of the sampled grating.

The optical cavity 50 formed between the rear reflecting face 13′ (FIG. 1) of the active layer 4 and the sampled-grating reflector 40 of length L has a length equal to the sum of the length Lₐ of the active portion 4 and the length L₁ between the inlet to the waveguide and the effective point at which light is reflected. In such a cavity, the spacing ΔvFP between two consecutive longitudinal resonant modes is given by the formula:

ΔvFP=c/2(nₐLₐ+n_{gf}L₁) (3)

in which:

nₐ and Lₐ represent respectively the value of the group index and the length of the active layer 4 between its rear face 13′ and its front face 13; and

L₁ is the length between the end of the waveguide or fiber 3 facing the active portion 4 and beginning in the present example shown in FIG. 1 at the lens 14, and the point in said fiber where the light reflected by the rear reflecting face 13′ is actually reflected by the sampled reflector 40.

In above formula (3), it can be seen that (nₐLₐ+n_{gf}L₁) represents the optical length of the optical cavity formed between the rear face 13′ and the Bragg reflector 40, ignoring the small distance between the lens 14 and the front face 13 of the active portion 4. Naturally, if this optical distance is not negligible, it needs to be taken into account. The length L1 can be determined by measuring the time taken by a light signal to propagate along the sampled grating.

With reference now to FIG. 3, the three portions A, B, and C are plotted on a common frequency scale, with portion A showing the spacing of the reflection peaks of the sampled Bragg reflector, portion B showing the frequency values corresponding to the resonant modes of the cavity formed between the rear face and the Bragg reflector, and with portion C showing the emission spectrum of the laser pulses emitted by the laser of the invention. Naturally, in order to obtain the desired operation, it is necessary to dimension the reflector in such a manner that its reflection peaks are sufficiently narrow to avoid overlap between a plurality of frequencies corresponding to resonant modes. For this purpose, it is possible for example to ensure that the half-height spectrum width of the reflection peaks is less than the spectrum gap between two consecutive resonant modes.

In the example described with reference to FIG. 3, the sampled Bragg reflector grating 40 is etched in the fiber 3 so that the spacing ΔvSG of the reflection peaks given by formula (1) above is equal to the spacing ΔvFP given by formula (3) above for the resonant modes of the Fabry-Perot cavity formed between the rear face 13′ of the active portion and the point of the waveguide 3 where light is effectively reflected. This fact is represented in FIG. 3 portions A and B where it can be seen that the reflection peaks of the waveguide 3 as rep-resented in portion A and the resonant modes of the cavity as represented in portion B lie one above another, thus showing that these peaks and these resonant modes corresponding to the same frequency values. The case shown in FIG. 3 corresponds to the case where P is equal to 1. In this case, the spectral components emitted by the laser 1 also lie at the same frequencies, as shown in portion C.

As explained above, the fiber 3 may also be etched in such a manner as the spacing ΔvSG of the reflection peaks given by above formula (1) is equal to some other integer multiple of the spacing ΔvFP given by above formula (3). Under such circumstances, for a given cavity, mode spacing will be as shown in portion B. However, if P=2 is taken by way of example, then every other peak will be omitted from portion A, with the frequencies corresponding to the resonant modes of the cavity 50 shown in portion B not changing since they depend only on the optical length of the cavity, whereas every other frequency will be omitted from portion C since the corresponding mode is not excited.

In operation, it is appropriate to be able to ensure that the frequencies of the reflection peaks coincide with the frequencies of the resonant modes. This can be done merely by servo-controlling the temperature of the portion 20 that includes the active layer 4. It is also possible to act on a phase section if such a section is provided, as in a variant embodiment described below.

If modulation is applied, e.g. amplitude or light frequency modulation of the laser waver, and a modulation frequency fₘ such that:

fₘ=ΔvSG=PΔvFP (4)

then mode locking is obtained, which means that the excited modes are synchronized in phase. The number of excited resonant modes of the Fabry-Perot cavity is equal to the number of reflection peaks in the sampled Bragg reflector 40, providing the gain curve of the active medium is of half-height bandwidth greater than the bandwidth of the envelope for the sampled grating reflection curve. The greater the number of peaks, the narrower the pulses it is possible to generate. By way of example, if the lengths of the Fabry-Perot cavity and the reflector 40 are designed so as to have a common spacing value of 40 GHz between resonant modes of the cavity and between consecutive peaks, and if there are ten reflection peaks, then the bandwidth Δv of the signal as emitted is 400 GHz. A Fourier transform of this signal from frequency space into time space leads to a pulse width Δt of the signal under these conditions being given by:

Δt=0.43/Δv=1 ps

It can thus be seen that the only limit on pulse shortness comes from the inter-band gain dynamics in the semiconductor material constituting the active layer 4.

With such a configuration, repetition frequency fluctuations are reduced, since the spacing of the reflection comb peaks in the segmented reflector can be controlled very tightly and the spectrum width of each peak can be very narrow.

Various embodiments of the sampled grating are described below.

The grating constituting each sample may be of varying pitch (chirped). It may also be apodized by appropriately modulating the depth of etching in the longitudinal direction of the grating. When the grating is of varying pitch, the pitch may vary in linear or other manner with longitudinal distance relative to a fixed point of the waveguide, said pitch decreasing going away from said first reflector. The advantage of such a varying pitch grating is that mode stability is increased, as explained in article [4] whose reference appears in the appendix to the present description. When the grating is apodized, the coupling coefficient between the go wave and the return wave for each period can vary so as to eliminate the reflection side lobes in the curve plotting reflection as a function of optical frequency.

Finally, in another variant embodiment it is possible to apply subharmonic modulation. Under such circumstances, the active region, or as described below a section for modulating the phase of said region, is modulated at a frequency whose value is the quotient of the difference between mode frequencies corresponding to the excited resonant modes of the Fabry-Perot cavity 50 divided by an integer number. This reduces the constraint on the need for high frequency electronics and on the modulation bandwidth of the chip.

Various embodiments of the active portion 20 are described below with reference to FIGS. 4 to 6. In these figures, elements having the same functions as those described with reference to FIG. 1 are given the same reference numerals. These elements having the same functions are not necessarily described above.

FIG. 4 shows an embodiment in which the semiconductor waveguide layer 4′ including the active medium is formed in two coupled-together portions 7 and 8 situated in line with each other. The first portion 7 of the waveguide layer 4′ is a gain portion, e.g. having multiple quantum wells formed by a first epitaxial operation. The second portion 8 of the waveguide layer 4′ is a waveguide portion presenting an electro-optical effect, e.g. a Franz-Keldysh effect, formed by a second selective epitaxial operation. Each of the portions 7 and 8 of the waveguide layer is integrated on a single InP substrate. The laser portion 20 is constituted in this case by two sections 5 and 6 on the single substrate 9. These two sections differ from each other in the nature of the waveguide layer 4′. The first portion 7 of the waveguide layer 4′ constitutes the active layer of the first section 5. The second portion 8 of the waveguide layer 4 is included in the second section 6. The two portions 7 and 8 of the waveguide layer are disposed in known manner within electrical and optical confinement layers that are not referenced in the figures. A metal contact layer 10, e.g. made of AuPt, is situated over the confinement layers. The two sections 5 and 6 are separated from each other by etching 12 formed through the contact layer 10 and through a portion of the confinement layers situated above the waveguide layer 4′. As a result, each of the two sections 5 and 6 can receive its own commands, e.g. in the form of a current injected into the first section 5 and in the form of a voltage applied to the second section 6. This makes it possible to change the optical length of the waveguide 4′ by controlling the voltage applied to the second section 6, without significantly influencing the power emitted by the laser.

This separates the gain function performed by the section 5 and the phase-matching function performed by the section 6. It can thus be relatively easy to achieve excellent matching between the spacing of the reflection peaks that result from making the Bragg grating in the waveguide and the spacing between the resonant modes of the Fabry-Perot cavity 50 which depends on the optical length of the cavity 50, which length can be made to vary independently by acting on a value controlling the section 6. Control of this section 6 can also be used to control modulation so as to produce frequency modulation by modulating the optical index at the frequency fₘ. Under such circumstances, the laser is locked by frequency modulation. Because of the frequency modulation at the frequency fₘ, each frequency component is in phase with the other frequency components (frequency modulation, mode-locked).

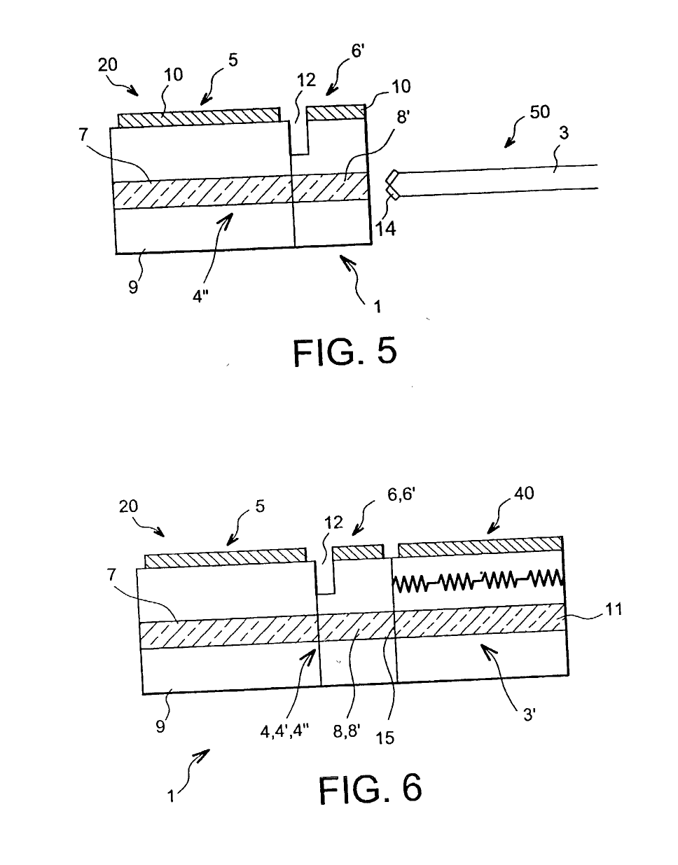

In another embodiment described below with reference to FIG. 5, the active portion 20 is formed as described above with reference to FIG. 4, comprising two sections 5 and 6′. The first portion 7 of the waveguide layer 4″ of the first section 5 is a gain layer as in the preceding example, e.g. using quantum wells. The second portion 8′ of the waveguide layer 4″ of the second section 6 is a saturable absorbent layer. This second portion 8′ of the waveguide layer may have quantum wells or a bulk material. As in the preceding case, the absorbent section 6′ is biased independently of the bias applied to the gain section 5. The bias of the absorbent section 6′ may either be a negative voltage applied to the n/p junction between the waveguide layer 8′ and an electrical confinement layer, or else it may be a low current. The second portion 8′ of the waveguide layer 4″ may be enriched in ions in order to reduce the lifetime of its carriers.

The configuration described with reference to FIG. 5 enables modes to be locked passively by passive switching of the absorbent section 6′.

This mode of operation makes it possible in particular to recover a clock in an all-optical manner. In this mode of operation, pulses produced by switching losses are synchronized in frequency and in phase with the frequency and the phase of the injected signal.

An embodiment in which the waveguide 3′ carrying the sampled Bragg reflector 40 is formed in a waveguide integral with the chip carrying the active portion 20 is described below with reference to FIG. 6.

For ease of manufacture, it is preferable to make the sampled waveguide in a fiber or a silica waveguide or a polymer waveguide as shown in FIGS. 1, 4, and 5. Under such circumstances, the silica or polymer waveguide or fiber can have the Bragg grating samples 31, 33 made therein by direct exposure. In particular, for fibers or waveguides made of silica, in addition to the well-known advantages of such waveguides such as low losses, thoroughly mastered technology, and reliability, it should be observed that the refractive index of such waveguides can be adjusted continuously by a procedure of illuminating the waveguide uniformly. This adjustment of the value of the refractive index makes it possible to achieve fine adjustment of the spacing between the reflectivity peaks ΔvSG.

However, the sampled grating can also be etched in an integrated InP waveguide, as shown in FIG. 6. Under such circumstances, and as shown in said figure, the waveguide portion 3′ is formed on the chip carrying the active portion 20 in a waveguide layer 11 having one end 15 in abutment against the waveguide layer 4 of the portion 20. As shown in FIG. 6, the portion 20 can be made in accordance with any of the embodiments described with reference to FIG. 1 or FIG. 4 or 5. Nevertheless, it should be observed that in this embodiment, present limitations mean that it is possible to produce only lasers operating at very high repetition frequencies, e.g. above 80 GHz because of the limited length that it is presently possible to obtain with such waveguides on semiconductors.

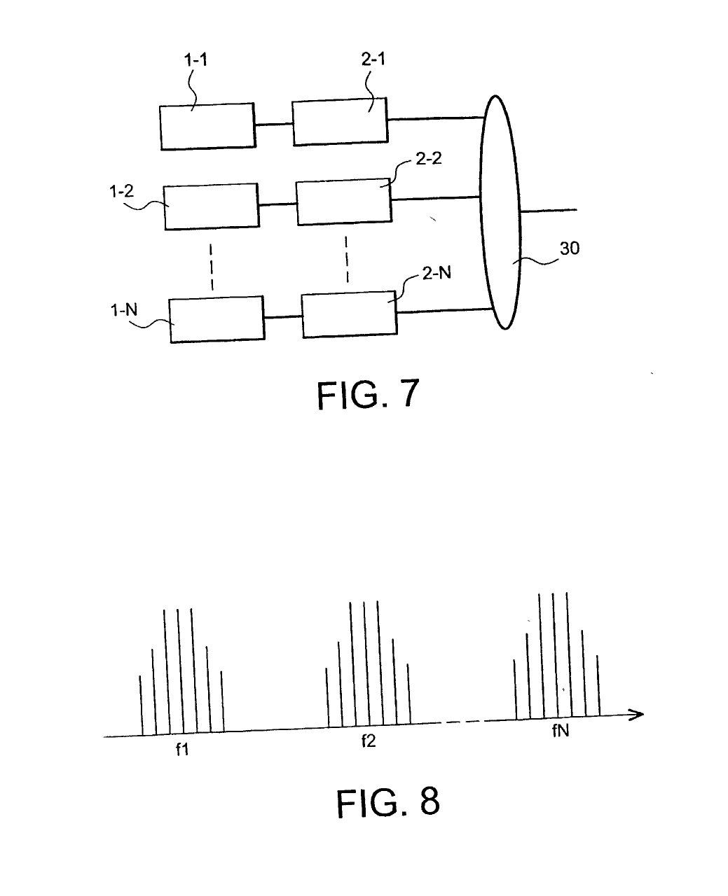

Lasers of the invention can advantageously be used for making WDM telecommunications systems. Under such circumstances, the center frequency of the sampled reflector grating allocated to each laser, and the envelope of the reflection peaks of the reflector should be selected in such a manner as to ensure there is no overlap between the reflection combs of the various lasers. FIG. 7 shows one such multiplexed grating of conventional design made up of N (where N is an integer) laser generators 1 given references 1-1 to 1-N. Each generator 1 is coupled to a respective modulator 2. Said modulators 2 are referenced 2-1 to 2-N. The N modulators are coupled to a multiplexer 30. FIG. 8 plots along a frequency axis the various reflection spectra of a first laser in accordance with the invention whose grating center frequency is set to a first frequency f1, together with that of second and nth lasers having respective grating center frequencies of f2 and fN. The various center frequencies f1, f2, and fN correspond to the frequencies of the International Telecommunications Union (ITU) frequency plan.

[image]

1/ A light pulse generator (1) including an active laser medium (4, 7) within a resonant cavity (50) defined between two reflectors (13′, 40), constituting a first reflector (13′) and a second reflector (40), the cavity (50) presenting mode frequency values at which the cavity is resonant, the second reflector (40) being constituted by a Bragg reflector, the generator being characterized in that said Bragg reflector (40) is constituted by a sampled Bragg grating (31-39) presenting a plurality of reflection peaks, each peak corresponding to a reflection frequency value, and in that the difference between consecutive reflection frequency values is equal to an integer multiple P of the difference between consecutive values of the mode frequencies.

2/ A light pulse generator (1) according to claim 1, characterized in that the Bragg reflector grating (40) presents varying pitch which decreases on going away from said first reflector (13′).

3/ A light pulse generator (1) according to claim 1 or claim 2, characterized in that the Bragg reflector grating (40) is modulated in depth of etching in a longitudinal direction of the grating (40).

4/ A light pulse generator (1) according to any one of claims 1 to 3, characterized in that the waveguide is an optical fiber (3) coupled to the laser active medium (4).

5/ A light pulse generator (1) according to any one of claims 1 to 3, characterized in that the waveguide (3′) is integrated on a chip including the laser active medium (4), a waveguide propagation medium (8) being situated in line with said active medium (4).

6/ A light pulse generator (1) according to any one of claims 1 to 5, characterized in that a waveguide layer (4′) including the laser active medium (7) is made up of two portions, namely a first portion (7) and a second portion (8) situated in line with each other, said two portions (7, 8) belonging respectively to first and second sections (5, 6, 6′), each of these sections (5, 6, 6′) having its own control input.

7/ A light pulse generator (1) according to claim 6, characterized in that the first section (5) is a gain section, and in that the second section (6) is a phase-matching section, the effective group index of said second portion (8) of the waveguide included in the phase-matching section (6) being adjustable by the electro-optical effect by changing the value of an electrical magnitude applied to said second section (6).

8/ A light pulse generator (1) according to claim 6, characterized in that the first section (5) is a gain section, and in that the second portion (8′) of the waveguide layer (4″) included in the second section (6′) is a saturable absorbent layer.

9/ A wavelength division multiplexed optical telecommunications system, characterized in that it comprises light pulse generators (1-1, . . . , 1-N) according to claim 7.

10/ An all optical clock signal recovery device, characterized in that it comprises a light pulse generator (1) according to claim 8.
